(19) United States
(12) Patent Application Publication
(10) Pub. No.: US 2010/0238275 A1
(43) Pub. Date: Sep. 23, 2010

(54) Method for Shortening or Lengthening a Viewing Distance between a Viewer and an Arrangement for Spatially Perceptible Display

(76) Inventors: Stephan Otte, Jena (DE); Markus Klippstein, Jena (DE)

Correspondence Address: JAMES F MCLAUGHLIN, 11 Ashwood Lane, Brookfield, CT, 06804, US

(21) Appl. No.: 12/679,481

(22) PCT Filed: Sep. 18, 2008
(86) PCT No.: PCT/DE2008/050029

§ 371 Date: Mar. 22, 2010

(30) Foreign Application Priority Data
Sep. 20, 2007 (DE) 102007045385.1

(51) Int. Cl. H04N 13/04

(52) U.S. Cl. 348/54; 348/E13.075

(57) ABSTRACT

The invention relates to the field of spatial representation, in particular to the spatially perceptible representation without auxiliary means for a plurality of observers at a time, the so-called autostereoscopic visualization. It is the object of the invention to create a possibility for autostereoscopic representation, allowing an adjustment of the observation distance independently of constraints for the configuration of the distance from the image display device to the optical element, for example a barrier or lenticular lens. This object is achieved by a method for spatial representation, in which partial image information of different views A(k), wherein k=1, . . . ,n and n>=2, is visualized on a grid (1) of image elements x(i,j), wherein on each image element x(i,j) exclusively the partial image information of precisely one of the views A(k) is visualized, and at least one optical element (2) is disposed upstream or downstream of the grid (1) of image elements x (i,j), wherein according to the invention the observation distance w and the average distance s between the at least one optical element (2) and the grid (1) of image elements x(i,j) are selected independently from each other.

The invention relates to the field of spatial display, in particular to a display that can be perceived in three dimensions simultaneously by several viewers without viewing aids, also known as autostereoscopic visualization.

Approaches to the said field have existed for quite some time. Frederic Ives, a pioneer in this field, presented a system with a “line screen” for 3D display in GB 190418672 A. Further, the article “Theory of parallax barriers” by Sam H. Kaplan, Journal of SMPTE Vol. 59, No 7, pp 11-21, July 1952, describes fundamental findings about the use of barrier screens for 3D display.

Attempts to gain autostereoscopic systems widespread use were unsuccessful for a long time, though. It was not until the 1980s that the computing power and novel display technologies then available made possible some renaissance of 3D systems. In the 1990s, the number of patent applications for, and publications on, 3D visualizations without stereo goggles soared. Outstanding results were achieved by the following inventors or suppliers:

In JP 08331605 AA, Masutani Takeshi et al. (Sanyo) describe a stepped barrier, in which a transparent barrier element has approximately the size of a color subpixel (R, G or B). This technology made it possible for the first time to partially divert to the vertical direction the horizontal resolution loss occurring in most autostereoscopic systems due to the simultaneous display of several (at least two, preferably more than two) views. Here, just as with all barrier methods, the high light loss is a disadvantage. Also, as the viewer moves sideways, the stereo contrast changes from almost 100% to about 50% and then again increases to 100%, which leads to a fluctuating 3D image quality in the viewing space.

With his teachings according to U.S. Pat. No. 5,808,599 A, U.S. Pat. No. 5,936,607 A and WO 00/10332 A1, Pierre Allio succeeded in making a remarkable advancement of lenticular technology, in which he also uses a subpixel-based division of views.

A patent on another outstanding result was applied for by Cees van Berkel with EP 791 847 A1. Here, lenticular lenses inclined from the vertical are overlaid on a display that also shows different perspective views. Characteristically, n views are distributed to at least two screen rows, so that again the resolution loss is partially diverted from the horizontal to the vertical.

However, lenticular lenses are complicated to fabricate, and the process of manufacturing a 3D display based on them is untrivial.

With U.S. Pat. No. 6,157,424 A and WO 02/35277 A1 and a number of other inventions, Jesse Eichenlaub set several milestones for autostereoscopy; almost all of these inventions, though, are 3D systems for only one viewer and/or often cannot be manufactured at acceptable cost.

With DE 100 03 326 C2, Armin Grasnick et al. succeeded in advancing the barrier technology with regard to two-dimensionally structured, wavelength-selective filter arrays for creating a 3D impression. This solution also suffers from the greatly impaired brightness of such 3D systems compared to a 2D display.

With WO 2005/027534 A2, Armin Schwerdtner succeeded in finding an innovative technological approach to a 3D display with full resolution in all (as a rule, two) views. However, this approach involves a great deal of adjustment work, and it is extremely difficult to implement for greater screen diagonals (of approx. 25 inches and greater).

Finally, Wolfgang Tzschoppe et al. filed patent application WO 2004/077839 A1, which relates to a barrier technology with improved brightness. Based on the approach of a stepped barrier as described in JP 08-331605 AA and DE 10 003 326 C2, this application discloses a special duty cycle between the transparent and opaque barrier filter elements, which is greater than 1/n, with n denoting the number of views displayed. However, the embodiments and teachings disclosed in this application produce, as a rule, unpleasant moiré effects and/or a greatly limited depth perception, as the stereo contrast—compared, e.g., with the teachings of JP 08-331605 AA—is greatly diminished.

DE 10133145 C2 teaches how to show, in one pixel, bits of partial image information in more than one view. By this method it is also possible to change the viewing distance via image manipulation. A drawback here is the mixing of image information in the pixels, which impairs 3D channel separation and, in part, greatly diminishes contrast as well as definition in the image.

Another disadvantage in prior art 3D systems is the fact that, because of the close connection between pixel size, viewing distance and the distance of the parallax barrier screen from the image generator (see also equations (1) and (2) in Kaplan's article cited above), the optimum 3D viewing distance is frequently too large. This is the case especially if, on the one hand, the pixels (as a rule, color subpixels) are very small while, on the other hand, the mechanical design of an image generator requires it to be located at a relatively large distance from the barrier screen, e.g., if an LCD panel is mounted in a comparatively thick metal frame, onto which a barrier screen is to be fixed by adhesive bonding. Although the 3D depth perception is particularly good then, the usefulness of such a system is greatly limited, because the minimum required 3D viewing distance is distinctly too great for practical use.

Therefore, it is the problem of the invention to provide way of autostereo-scopic display that permits the viewing distance to be adapted indepen-dently of constraints regarding the dimensioning of the distance between the image display device and the optical element, such as, e.g., the barrier or lenticular.

According to the invention, the problem is solved by a method for shortening or lengthening a viewing distance between a viewer and the arrangement for a spatially perceivable display, in which

bits of partial image information from different views A(k) with k=1, . . . ,n and n>2 are made visible on a grid of pixels x(i,j) with rows i and columns j in such a way that, on each pixel x(i,j), exclusively one bit of partial information of exactly one of the views A(k) is made visible, and

arranged in front of or behind the grid of pixels x(i,j) at a distance s is at least one optical element with periodically arranged optical structures, which defines the propagation directions for the light transmitted or radiated by the pixels x(i,j),

the mean smallest horizontal and/or vertical period length, or a multiple thereof, of the optical structures on the at least one optical element is an integral multiple of the mean horizontal and/or vertical dimension of a pixel x(i,j), multiplied by a correction factor f,

with the correction factor f being calculated as a function of a selectable viewing distance w and the mean distance s between the at least one optical element and the grid of pixels x(i,j),

so that, because of the optical effect of the at least one optical element, one or several viewers looking at the grid will exclusively or predominantly see different pixels x(i,j) and/or parts thereof with each of their two eyes, so that each of the two eyes exclusively or predominantly perceives different views A(k) and, thus, a spatial visual impression results.

The said problem is solved in such a way that the viewing distance w is shortened by application of the inequation s/ha>w/pa, with the mean distance s between the at least one optical element and the grid of pixels x(i,j) and the mean interpupillary distance pa remaining unchanged, whereas the mean smallest horizontal period length of the optical structure is decreased by a targeted change of the correction factor f or, alternatively, that the viewing distance w is lengthened by application of the inequation s/ha<w/pa, with the mean distance s between the at least one optical element and the grid of pixels x(i,j) and the mean interpupillary distance pa also remaining unchanged, whereas the mean smallest horizontal period length of the optical structure is increased by a targeted change of the correction factor f This is applicable for the case that the optical element is (in the viewing direction) situated in front of the grid of pixels; otherwise, the smallest period length of the optical structure would be changed in the respective reverse way, i.e. increased or decreased, respectively. Generally, the horizontal increase/decrease of the smallest period length of the optical structure is also accompanied by a vertical increase/decrease of the smallest period length of the optical structure, which is caused by the correction factor f.

Here, let the mean smallest horizontal and/or vertical period length of the optical structures on the at least one optical element be defined as the mean horizontal or vertical distance, respectively, of one point on an optical structure from an identical point belonging to the nearest neighbor optical structure.

The mean distance s between the at least one optical element and the grid of pixels x(i,j) is understood to be, in particular, the mean distance between an optically effective surface or plane of the optical element and the image-generating surface of a grid of pixels x(i,j).

The viewing distance w is understood to be, in particular, the distance of the optically effective surface or plane of the optical element from a viewer's eye. Although the invented method allows for several possible viewing distances, one of them is the outstanding (optimum) viewing distance w.

The correction factor f is preferably calculated by the equation f=w/(w+s).

The particular advantage of the invention is that the outstanding viewing distance w of one or several viewers can be decreased compared to prior art by applying the inequality s/ha>w/pa, with the mean distance s between the at least one optical element and the grid of pixels x(i,j) as well as the mean interpupillary distance pa, a quantity given by nature, remaining unchanged, whereas the mean smallest horizontal period length of the optical structure is decreased by a targeted change of the correction factor f. This makes it possible to arrange the optical element at a comparatively great distance s from the grid of pixels x(i,j) without having to put up with too great a viewing distance w. The dimensioning of the correction factor f according to the invention then makes sure that, nevertheless, a practically acceptable viewing distance w is implemented, and that without having to perform any manipulation of the image content as required in prior art, e.g. as described in DE 101 33 145 C2.

It is also possible, of course, for the outstanding viewing distance w of one or several viewers to be increased compared to prior art by applying the inequality s/ha>w/pa, with the mean distance s between the at least one optical element and the grid of pixels x(i,j) as well as the mean interpupillary distance pa also remaining unchanged, whereas the mean smallest horizontal period length of the optical structure is increased by a targeted change of the correction factor f. This case is likely to be applied less frequently in practice, although it is particularly easy to implement by the invented method.

Furthermore, the pixels x(i,j) correspond to individual color subpixels (R, G or B) or clusters of color subpixels (e.g., RG, GB or RGBR or others) or full-color pixels, the term full-color pixels meaning both white-mixing structures of RGB color subpixels, i.e. RGB triplets, and—depending on the image generation technology—actual full-color pixels, as frequently used, e.g., in projection screens.

In a favorable embodiment of the method, the optical element is a parallax barrier screen, which comprises, as optical structures, transparent and opaque segments, which may be shaped, e.g., like straight-lined or wave-like stripes or stepped areas, as suggested in some of the documents cited above.

It is also possible, however, for the optical element to be a lenticular screen, which comprises cylindrical lenses as optical structures.

In the invented method, the views A(k) as a rule correspond to different perspectives of a scene or object. However, they may just as well be parallel projections of a scene or views produced in other ways.

In the invented method, the bits of partial image information from different views A(k) are arranged on the grid of pixels x(i,j) favorably in a two-dimensional periodic pattern, with the period length in the horizontal and vertical directions preferably comprising not more than 32 pixels x(i,j) each. Exceptions from this upper limit of 32 pixels x(i,j) each are admissible, of course.

Preferably the vertical period length is equal to the number n of the views displayed.

As a rule, the angle that constitutes the said horizontal and vertical period length of the said two-dimensional periodic pattern as opposite leg and adjacent leg should essentially correspond to the angle of inclination of the transparent segments on the parallax barrier screen (if the optical element is such a one) relative to the vertical. In this way, the best channel separation in 3D display is achieved.

In a first embodiment of the arrangement used in the method, the optical element is a parallax barrier screen, which comprises transparent and opaque segments as optical structures. Preferably, the transparent segments correspond to stripes or stepped areas, which are essentially inclined relative to the vertical by an angle of inclination a. There is no restriction as to the size of the angle of inclination a. Explicitly, the inclination relative to the vertical may also be zero.

In a second embodiment it is further possible for the optical element to be a lenticular screen that comprises cylindrical lenses as optical structures. Here again, the cylindrical lenses are preferably arranged at an angle of inclination a relative to the vertical. Here again, the angle of inclination a may have any size, including the possibility of zero inclination relative to the vertical.

Further embodiments of the arrangement with regard to the optical elements are feasible as well, e.g. such using holographic-optical elements.

The image display device to be used is preferably a color LCD screen, a plasma display, a projection screen, an LED-based screen, an OLED-based screen, an SED screen or a VFD screen.

Furthermore, the number n of the views A(k) may, e.g., be equal to 4, 5, 6, 7, 8 or 9, and the said horizontal period length may, e.g. correspond to n pixels x(i,j). However, the number n of the views A(k) may also be greater or smaller than specified herein.

For the embodiment of the optical element as a parallax barrier screen, the following details are favorable in addition:

In order to obtain arrangements that manufacture well in practice, the parallax barrier screen preferably consists of a glass substrate, with the barrier structure being applied to the rear side of that substrate. Other embodiments are possible, such as substrates consisting of materials other than glass (e.g., of plastic).

Preferably, the barrier structure is an exposed and developed photographic film laminated to the rear side of the glass substrate, with the emulsion layer of the photographic film preferably facing the glass substrate. Alternatively it is also possible for the opaque areas of the barrier structure to be formed by ink printed onto the glass substrate.

Furthermore, it is advantageous for the parallax barrier screen to comprise means for reducing disturbing light reflections, preferably at least one interference-optical antireflection coat. It is also possible, though, to use common antiglare mattings.

It is advantageous for the parallax barrier screen to be permanently mounted, e.g., bonded or screwed, to the image display device by means of a spacer. Alternatively, it may also be desirable to design the parallax barrier screen in such a way that it is temporarily removable from the image display device.

Below, the invention will be explained in more detail in exemplary embodiments and with reference to the accompanying drawings in which:

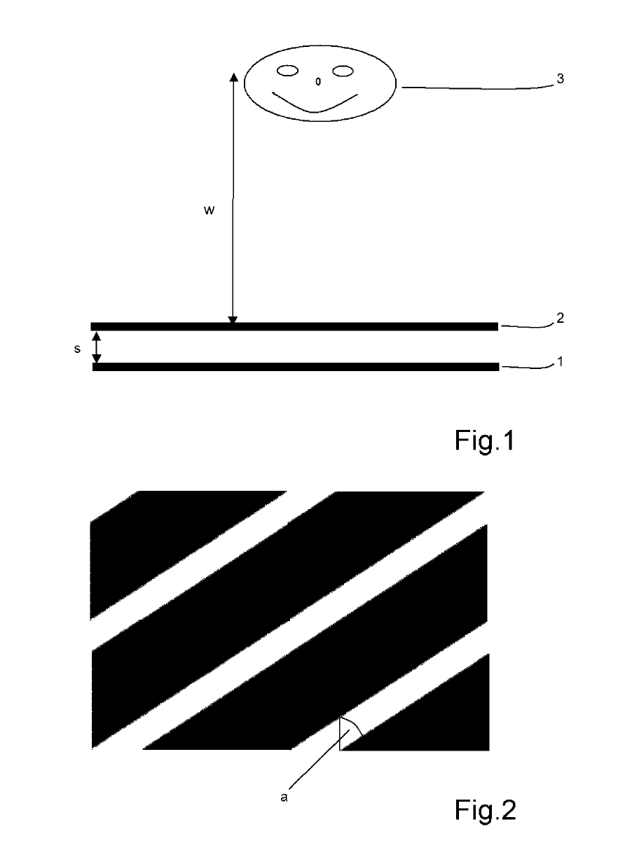

FIG. 1 shows the schematic setup for implementing the invented method,

FIG. 2 is a sketch of a parallax barrier screen for use in the invented method,

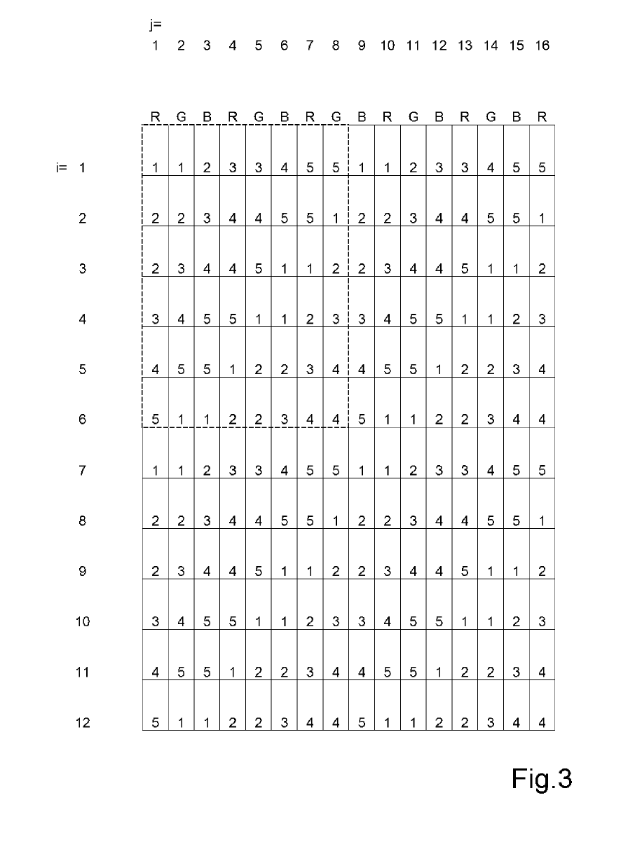

FIG. 3 shows an example of an image interweaving pattern of the bits of partial image information from different views,

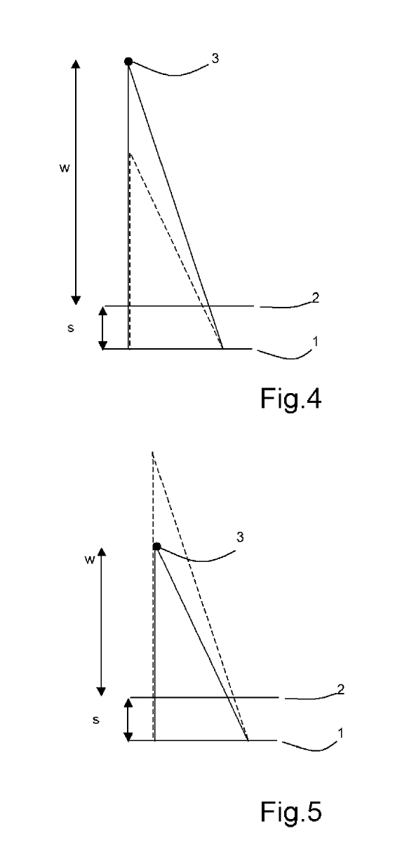

FIG. 4 is an illustration of the effect according to the invention with an increased viewing distance,

FIG. 5 is an illustration of the effect according to the invention with a decreased viewing distance,

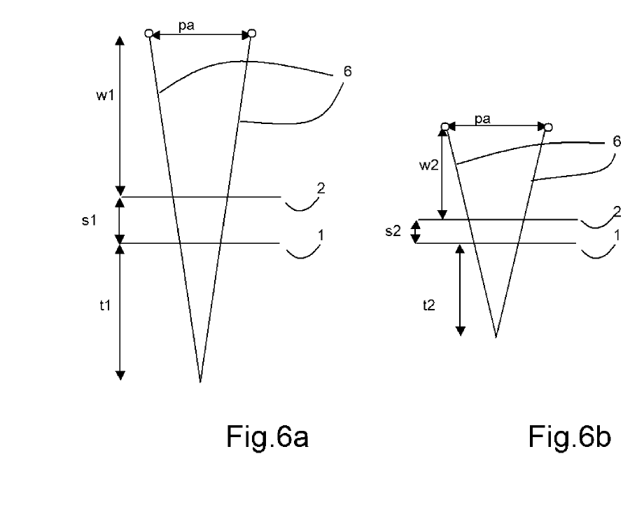

FIGS. 6a and 6b is a sketch explaining the increase in depth impression for the case of a reduced viewing distance,

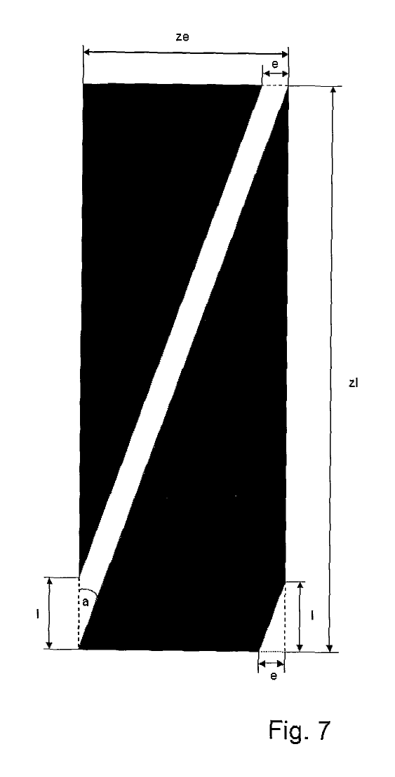

FIG. 7 shows a section of a parallax barrier screen illustrating its essential parameters.

None of the drawing is made to scale. This also, and in particular, applies to angular dimensions.

FIG. 1 shows the schematic setup for implementing the invented method.

It contains a grid 1 of pixels x(i,j), on which bits of partial image information from different views A(k) with k=1, . . . ,n and n>=2 are made visible so that on each pixel x(i,j) exclusively the partial image information from exactly one of the views A(k) is made visible.

Arranged in front of the grid 1 of pixels x(i,j) at a distance s in the viewing direction of a viewer 3 is at least one optical element 2 with optical structures in essentially periodic arrangement; this optical element defines propagation directions for the light transmitted or radiated by the pixels x(i,j). In this example, exactly one optical element 2 is provided, which is designed as a parallax barrier screen 2. As a matter of course, there may also be several viewers 3 who gain an impression of space thanks to the invented method.

FIG. 2 shows a section of a parallax barrier screen 2 as an example for use in the invented method. This parallax barrier screen 2 contains alternating opaque and transparent segments, with the transparent segments being stripes essentially bounded by straight lines in accordance with the invention. The transparent and opaque segments are arranged so as to be periodically repeated; they correspond to the optical structures on the parallax barrier screen 2. Their mean smallest horizontal and vertical period length is an integral multiple of the mean horizontal and vertical dimensions of a pixel x(i,j) multiplied by a correction factor f this correction factor f being calculated as a function of a selectable viewing distance wand the distance s between the optical element 2 and the grid 1 of pixels x(i,j).

FIG. 3 shows an example of an image interweaving pattern of the bits of partial image information from, for example, five different views A(k) with k=1, . . . ,5. In the invented method, the bits of partial image information from different views A(k) are arranged on the grid 1 of pixels x(i,j) preferably in a rigorously two-dimensional periodic pattern. In the example illustrated by FIG. 3, the horizontal period length comprises eight, and the vertical period length six, pixels x(i,j), indicated by the broken-line frame. The partial image information for each pixel x(i,j) originates from the position (i,j) in the respective view A(k).

Thus, in the embodiment example shown here, the vertical period length does not correspond to the number n=5 of the views displayed.

Because of the viewing restriction effected by the parallax barrier screen 2, the two eyes of one or several viewers 3 will see essentially different pixels x(i,j) and/or parts thereof, so that each of the two eyes perceives essentially different views A(k), which results in a spatial visual impression. Up to a certain degree, the two eyes of one and the same viewer 3 may even see bits of partial image information of the same view A(k) without the impression of space being spoiled.

Furthermore, the pixels x(i,j) correspond to individual color subpixels (R, G or B).

The relationships illustrated in FIGS. 1 through 3 provided, the (optimum or selected) viewing distance wand the distance s between the optical element 2, i.e. the parallax barrier screen, and the grid 1 of pixels x(i,j) are selected independently of each other, in accordance with the invention. Unlike in prior art, the quantities wand s are, in particular, not related to each other via a given intraocular distance or/and the dimension of a pixel x(i,j).

The correction factor f is calculated by the equation f=w/(w+s).

In the invented method, the views A(k) correspond to different perspectives of a scene or object, as a rule. But they may just as well be parallel projections of a scene, or views produced otherwise.

The angle that constitutes the said horizontal and vertical period length of the said two-dimensional periodic pattern as opposite leg and adjacent leg essentially corresponds to the angle of inclination a (see FIG. 2) of the transparent segments on the parallax barrier screen 2 relative to the vertical. In FIG. 3, the opposite leg could be defined, e.g., via the lower horizontal broken line, and the adjacent leg via the right vertical broken line.

In this way, as a rule, the best channel separation in 3D display is achieved.

FIG. 4 illustrates the effect according to the invention, with the viewing distance w being increased compared to prior art.

For the viewing distance w of one or several viewers 3, the distance s between the parallax barrier screen 2 and the grid 1 of pixels x(i,j), the mean interpupillary distance pa and the mean horizontal dimension ha of a pixel x(i,j), the inequation s/ha<w/pa applies, which is not directly evident from the drawing. The broken lines clearly show the relationships prevailing in prior art, where this inequation explicitly does not apply.

By comparison, FIG. 5 is an illustration of the effect according to the invention, with the viewing distance w of one or several viewers 3 being decreased compared to prior art.

This makes evident special advantages of the invention. Here, for the viewing distance w, the distance s between the parallax barrier screen 2 and the grid 1 of pixels x(i,j), the mean interpupillary distance pa and the mean horizontal dimension ha of a pixel x(i,j), the inequation s/ha>w/pa applies, which is not directly evident from the drawing.

In this case of application, the optical element, or the parallax barrier screen 2, respectively, may be arranged at a relatively great distance s from the grid of pixels x(i,j). The dimensioning of the correction factor f according to the invention ensures that, nevertheless, a practically acceptable viewing distance w can be implemented, and that without the need of any manipulation of the image content.

Here again, the broken lines indicate the relationships prevailing in prior art. It is plainly evident that the invented method decreases the viewing distance w to a practically relevant range.

FIG. 6a and FIG. 6b each show a sketch that explains the increase in depth impression for the case of decreasing the viewing distance. In FIG. 6a it can be seen how a great perceived depth t1 is achieved at a viewing distance w1 conditioned in prior art by a distance s1. The eyes of a viewer 3 spaced by the distance pa are indicated by small circles.

The comparison with FIG. 6b, in which a smaller viewing distance w2 conditioned by a smaller distance s2 in prior art results in a shallower perceived depth f2, makes evident the substantial influence of the physical distance s on the aim of achieving the greatest possible depth impression. In both drawings (FIGS. 6a and 6b), the trace points of the viewing rays 6 on the parallax barrier screen 2 and on the grid 1 of pixels x(i,j) are situated in the same places, i.e. at the same pixels x(i,j) and in exactly the same positions of the transparent segments. Unlike this, the invented solution makes it possible to dissolve the relationship between wand s and to decrease the viewing distance w despite a great distance s, as shown in FIG. 5. Still, the relatively great depth impression is retained.

FIG. 7 is a schematic showing the parallax barrier screen 2 with dimensions, in which a is the angle of inclination of the transparent or opaque segments relative to the vertical, e is the width of the said segments in the horizontal direction of the grid of pixels x(i,j), l is their height, ze is their horizontal period, and zl is their vertical period.

For the further illustration of an example of an arrangement for implementing the invented method, reference is made again to the drawings FIG. 1 through FIG. 7.

FIG. 1 shows the schematic setup for implementing the invented method. It comprises image display device 1 with pixels x(i,j) in a grid (i,j) with rows i and columns j, on which bits of partial image information from different views A(k) with k=1, . . . ,n and n>=2 can be made visible in such a way that on each pixel x(i,j) exclusively the partial image information from exactly one of the views A(k) is made visible.

Arranged in front of or behind the grid 1 of pixels x(i,j) at a distance s in the viewing direction of a viewer 3 is at least one optical element 2 with optical structures in essentially periodic arrangement; this optical element defines propagation directions for the light transmitted or radiated by the pixels x(i,j). In this example, exactly one optical element 2 is provided, which is designed as a parallax barrier screen 2. As a matter of course, there may also be several viewers 3 who gain an impression of space thanks to the invented method.

FIG. 2 shows a section of a parallax barrier screen 2 as an example for use in the arrangement according to the invention. This parallax barrier screen 2 contains alternating opaque and transparent segments, with the transparent segments preferably being stripes essentially bounded by straight lines. The transparent and opaque segments are arranged so as to be periodically repeated; they are the optical structures on the parallax barrier screen 2. Their mean smallest horizontal and vertical period length is an integral multiple of the mean horizontal and vertical dimensions of a pixel x(i,j) multiplied by a correction factor f this correction factor f being calculated as a function of a selectable viewing distance wand the mean distance s between parallax barrier screen 2 and the image display device 1 with the pixels x(i,j), so that one or several viewers 3 looking at the image display device 1 will, because of the optical effect of the parallax barrier screen 2, each see exclusively or essentially different pixels x(i,j) and/or parts thereof with their two eyes, so that each of the two eyes perceives exclusively or essentially different views A(k), which results in a spatial visual impression.

For the embodiment of the optical element as a parallax barrier screen 2, the following details are favorable in addition:

In order to obtain arrangements that manufacture well in practice, the parallax barrier screen 2 preferably consists of a glass substrate, with the barrier structure being applied to the rear side of that substrate. Preferably, the barrier structure is an exposed and developed photographic film laminated to the rear side of the glass substrate, with the emulsion layer of the photographic film preferably facing the glass substrate.

Furthermore, it is advantageous for the parallax barrier screen 2 to comprise means for reducing disturbing light reflections, preferably at least one interference-optical antireflection coat. It is advantageous for the parallax barrier screen 2 to be permanently mounted, e.g., bonded or screwed, to the image display device by means of a spacer. Alternatively, it may also be desirable to design the parallax barrier screen 2 in such a way that it is temporarily removable from the image display device 1.

FIG. 3 shows an example of an image interweaving pattern of the bits of partial image information from, for example, five different views A(k) with k=1, . . . ,5. In the arrangement according to the invention, the bits of partial image information from different views A(k) are arranged on the grid 1 of pixels x(i,j) preferably in a rigorously two-dimensional periodic pattern. In the example illustrated by FIG. 3, the horizontal period length comprises eight, and the vertical period length six, pixels x(i,j), indicated by the broken-line frame. The partial image information for each pixel x(i,j) originates from the position (i,j) in the respective view A(k).

Thus, in the embodiment example shown here, the vertical period length does not correspond to the number n=5 of the views displayed.

Because of the viewing restriction effected by the parallax barrier screen 2, the two eyes of one or several viewers 3 will see essentially different pixels x(i,j) and/or parts thereof, so that each of the two eyes perceives essentially different views A(k), which results in a spatial visual impression. Up to a certain degree, the two eyes of one and the same viewer 3 may even see bits of partial image information of the same view A(k) without the impression of space being spoiled.

Furthermore, the pixels x(i,j) in this example correspond to individual color subpixels (R, G or B).

The relationships illustrated in FIGS. 1 through 3 provided, the (optimum or selected) viewing distance w and the mean distance s between the optical element 2, i.e. the parallax barrier screen 2, and the image display device 1 with the grid of pixels x(i,j) are selected independently of each other, in accordance with the invention. Unlike in prior art, the quantities wand s are, in particular, not related to each other via a given intraocular distance or/and the dimension of a pixel x(iⱼ).

The correction factor f is calculated by the equation f=w/(w+s).

In the invention, the views A(k) correspond to different perspectives of a scene or object, as a rule. But they may just as well be parallel projections of a scene, or views produced otherwise.

The angle that constitutes the said horizontal and vertical period length of the said two-dimensional periodic pattern as opposite leg and adjacent leg essentially corresponds to the angle of inclination a (see FIG. 2) of the transparent segments on the parallax barrier screen 2 relative to the vertical. In FIG. 3, the opposite leg could be defined, e.g., via the lower horizontal broken line, and the adjacent leg via the right vertical broken line.

In this way, as a rule, the best channel separation in 3D display is achieved.

FIG. 4 illustrates the effect according to the invention, with the viewing distance w being increased compared to prior art.

For the viewing distance w of one or several viewers 3, the mean distance s between the parallax barrier screen 2 and the grid 1 of pixels x(i,j), the mean interpupillary distance pa and the mean horizontal dimension ha of a pixel x(i,j), the inequation s/ha<w/pa applies, which is not directly evident from the drawing. The broken lines indicate the relationships prevailing in prior art, where this inequation would not apply, and where the viewing distance would be shorter.

By comparison, FIG. 5 is an illustration of the effect according to the invention, with the viewing distance w of one or several viewers 3 being decreased compared to prior art.

This results in special advantages of the invention. Here, for the viewing distance w, the distance s between the parallax barrier screen 2 and the grid 1 of pixels x(i,j), the mean interpupillary distance pa and the mean horizontal dimension ha of a pixel x(i,j), the inequation s/ha>w/pa applies, which is not directly evident from the drawing.

In this case of application, in fact, the parallax barrier screen 2 may be arranged at a relatively great distance s from the image display device 1 with the grid of pixels x(i,j). The dimensioning of the correction factor f according to the invention ensures that, nevertheless, a practically acceptable viewing distance w can be implemented, and that without the need of any manipulation of the image content, such as, e.g., the mixing of bits of partial image information from several views in one pixel x(i,j).

Here again, the broken lines indicate the relationships prevailing in prior art. It is plainly evident that the arrangement according to the invention decreases the viewing distance w to a practically relevant range.

FIG. 6a and FIG. 6b each show a sketch that explains the increase in depth impression for the case of decreasing the viewing distance. In FIG. 6a it can be seen how a great perceived depth t1 is achieved at a viewing distance w1 conditioned in prior art by a distance s1. The eyes of a viewer 3 spaced by the distance pa are indicated by small circles.

The comparison with FIG. 6b, in which a smaller viewing distance w2 conditioned by a smaller distance s2 in prior art results in a shallower perceived depth t2, makes evident the substantial influence of the physical distance s on the aim of achieving the greatest possible depth impression. In both drawings (FIGS. 6a and 6b), the trace points of the viewing rays 6 on the parallax barrier screen 2 and on the grid 1 of pixels x(i,j) are situated in the same places, i.e. at the same pixels x(i,j) and in exactly the same positions of the transparent segments. Unlike this, the invented solution makes it possible to dissolve the relationship between w and s and to decrease the viewing distance w despite a great distance s, as shown in FIG. 5. Still, the relatively great depth impression desired is retained.

FIG. 7 is a schematic showing the dimensioning of the parallax barrier screen 2, in which a is the angle of inclination of the transparent or opaque segments relative to the vertical, e is the width of the said segments in the horizontal direction of the grid of pixels x(i,j), l is their height, ze is their horizontal period, and zl is their vertical period.

Eligible as an image display device 1 is, e.g., an 8.4″ LCD screen with color subpixels (R, G, B) as pixels x(i,j), the height of the pixels x(i,j) being about 0.1665 mm and their width ha being about 0.0555 mm. The transparent segments of the parallax barrier screen 2 have an angle of inclination a=23.96248897° relative to the vertical. The width e of the said segments in horizontal direction of the grid of pixels x(i,j) is 0.1109054 mm, and their height l=0.249537 mm. Further, the horizontal period ze=0.4436216 mm, the distance s=1.91 mm, and the viewing distance w=800 mm. Finally, the vertical period of the transparent segments zl=0.998148 mm. This means that, here, the viewing distance has been shortened, because the inequation s/ha>w/pa is satisfied, with the human mean interpupillary distance pa in this inequation being between 55 mm and 70 mm, as a rule.

In prior art, for a viewing distance of w=800 mm, a distance s=0.68308 mm would have to be implemented under the conditions mentioned above, which could only be achieved at great technical and practical effort. Thanks to the invention, this effort can be saved.

The advantages of the invention are many and varied. In particular, the invented method and the corresponding arrangements permit an autostereoscopic display in which it is possible to set, by means of hardware, the 3D viewing distance as desired for a minimum distance between the optical element and the screen, i.e. the grid of pixels, despite certain mechanical constraints. In the case of shortening the viewing distance, even the relative depth perceptions can be enhanced.

The invention can be implemented by very simple means; if parallax barrier screens are used it is only necessary to slightly alter the barrier structure, while no change is required to the process of manufacturing an appropriate 3D screen.

What is claimed is:

1. A method for the shortening or lengthening of a viewing distance between a viewer and an arrangement of a spatially perceptible display, in which
bits of partial image information from different views A(k) with k=1, . . . ,n and n>2 are made visible on a grid (1) of pixels x(i,j) with rows i and columns j in such a way that, on each pixel x(i,j), exclusively one bit of partial information of exactly one of the views A(k) is made visible, and arranged in front of or behind the grid (1) of pixels x(i,j) at a distance s is at least one optical element (2) with periodically arranged optical structures, which defines the propagation directions for the light transmitted or radiated by the pixels x(i,j),
the mean smallest horizontal and/or vertical period length, or a multiple thereof, of the optical structures on the at least one optical element (2) is an integral multiple of the mean horizontal and/or vertical dimension of a pixel x(i,j), multiplied by a correction factor f,
with the correction factor f being calculated as a function of a selectable viewing distance w and the mean distance s between the at least one optical element (2) and the grid (1) of pixels x(i,j),
so that, because of the optical effect of the at least one optical element (2), one or several viewers (3) looking at the grid (1) will exclusively or predominantly see different pixels x(i,j) and/or parts thereof with each of their two eyes, so that each of the two eyes exclusively or predominantly perceives different views A(k) and, thus, a spatial visual impression results, characterized in that
the viewing distance w is shortened by application of the inequation s/ha>w/pa, with the mean distance s between the at least one optical element (2) and the grid (1) of pixels x(i,j) and the mean interpupillary distance pa remaining unchanged, whereas the mean smallest horizontal period length of the optical structure is decreased by a targeted change of the correction factor f or that
the viewing distance w is lengthened by application of the inequation s/ha<w/pa, with the mean distance s between the at least one optical element (2) and the grid (1) of pixels x(i,j) and the mean interpupillary distance pa also remaining unchanged, whereas the mean smallest horizontal period length of the optical structure is increased by a targeted change of the correction factor f.

2. A method as claimed in claim 1, characterized in that the correction factor f is calculated by the equation f=w/(w+s).

3. A method as claim 2, characterized in that the pixels x(i,j) correspond to color subpixels (R, G or B) or clusters of color subpixels (e.g., RG or GB) or full-color pixels.

4. A method as claimed in claim 3, characterized in that a parallax barrier screen is used as the optical element (2), which comprises transparent and opaque segments as optical structures.

5. A method as claimed in claim 4, characterized in that a lenticular screen is used as the optical element (2), the optical structures being implemented by an appropriate arrangement of the cylindrical lenses.

6. A method as claimed in claim 4, characterized in that the transparent segments correspond to straight or wave-shaped stripes or stepped areas, which are essentially inclined at an angle of inclination a relative to the vertical.

7. A method as claimed in claim 5, characterized in that the cylindrical lenses are arranged essentially inclined at an angle of inclination a relative to the vertical.

8. A method as claimed in claim 7, characterized in that the assignment of the bits of partial image information from different views A(k) to the pixels x(i,j) follows a two-dimensional periodic pattern, with the period length in the horizontal and the vertical direction each comprising preferably not more than 32 pixels x(i,j).

9. A method as claimed in claim 8, characterized in that the vertical period length is equal to the number n of the views displayed.

10. A method as claimed in claim 9, characterized in that the image display device (1) used is a color LCD screen, a plasma display, a projection screen, an LED-based screen, an OLED-based screen, an SED screen or a VFD screen.

11. A method as claimed in claim 10, characterized in that the number n of the views A(k) equals 4, 5, 6, 7, 8 or 9 and the said horizontal period length corresponds to n pixels x(i,j).

12. A method as claimed in claim 1, characterized in that the image display device (1) used is an 8.4″ LCD screen with color subpixels (R, G, B) as pixels x(i,j), in which the height of the pixels x(i,j) is about 0.1665 mm and the width is about 0.0555 mm, and the bits of partial image information from different views A(k) are arranged as follows,
$$\begin{matrix}x ( i , j ) & 1 & 2 & 3 & 4 & 5 & 6 & 7 & 8 & 9 & … \\ 1 & A ( 1 ) & A ( 1 ) & A ( 2 ) & A ( 3 ) & A ( 3 ) & A ( 4 ) & A ( 5 ) & A ( 5 ) & A ( 1 ) & … \\ 2 & A ( 2 ) & A ( 2 ) & A ( 3 ) & A ( 4 ) & A ( 4 ) & A ( 5 ) & A ( 5 ) & A ( 1 ) & A ( 2 ) & … \\ 3 & A ( 2 ) & A ( 3 ) & A ( 4 ) & A ( 4 ) & A ( 5 ) & A ( 1 ) & A ( 1 ) & A ( 2 ) & A ( 2 ) & … \\ 4 & A ( 3 ) & A ( 4 ) & A ( 5 ) & A ( 5 ) & A ( 1 ) & A ( 1 ) & A ( 2 ) & A ( 3 ) & A ( 3 ) & … \\ 5 & A ( 4 ) & A ( 5 ) & A ( 5 ) & A ( 1 ) & A ( 2 ) & A ( 2 ) & A ( 3 ) & A ( 4 ) & A ( 4 ) & … \\ 6 & A ( 5 ) & A ( 1 ) & A ( 1 ) & A ( 2 ) & A ( 2 ) & A ( 3 ) & A ( 4 ) & A ( 4 ) & A ( 5 ) & … \\ 7 & A ( 1 ) & A ( 1 ) & A ( 2 ) & A ( 3 ) & A ( 3 ) & A ( 4 ) & A ( 5 ) & A ( 5 ) & A ( 1 ) & … \\ … & … & … & … & … & … & … & … & … & … & …\end{matrix} ,$$
with the following quantities being fixed so that the transparent segments of the parallax barrier screen (2) relative to the vertical have an angle of inclination a=23.96248897°, the width e of the said segments in the horizontal direction of the grid of pixels x(i,j)=0.1109054 mm and their height l=0.249537 mm, the horizontal period ze=0.4436216 mm, the distance s=1.91 mm, the viewing distance w=800 mm, and the vertical period of the transparent segments zl=0.998148 mm.
